(19) United States
(12) Patent Application Publication
(10) Pub. No.: US 2024/0145966 A1
(43) Pub. Date: May 2, 2024

(54) Method for Manufacturing Electrically Conductive Terminal and Electrically Conductive Terminal

(71) Applicants: Tyco Electronics AMP Guangdong Ltd, Foshan City (CN); Tyco Electronics (Shanghai) Co., Ltd., Shanghai (CN)

(72) Inventors: Jiaoyong (Mac) Liu, Shanghai (CN); Jialin Zhang, Shanghai (CN); Hongqiang (Sean) Han, Shanghai (CN); Likun Ma, Foshan (CN)

(73) Assignees: Tyco Electronics AMP Guangdong Ltd, Foshan City (CN); Tyco Electronics (Shanghai) Co., Ltd., Shanghai (CN)

(21) Appl. No.: 18/494,857

(22) Filed: Oct. 26, 2023

(30) Foreign Application Priority Data
Oct. 26, 2022 (CN) 202211320331.4

(51) Int. Cl. H01R 13/03; C23C 28/00; H01R 43/16

(52) U.S. Cl. CPC H01R 13/03; C23C 28/321; C23C 28/345; H01R 43/16

(57) ABSTRACT

A method for manufacturing an electrically conductive terminal includes steps of plating a nickel plating layer on a surface of the conductive metal base layer, plating a silver plating layer on a surface of the nickel plating layer, and plating a tin plating layer on a surface of the silver plating layer.

### CROSS-REFERENCE TO RELATED APPLICATION

This application claims the benefit of Chinese Patent Application No. 202211320331.4 filed on Oct. 26, 2022, in the State Intellectual Property Office of China, the whole disclosure of which is incorporated herein by reference.

### FIELD OF THE INVENTION

Embodiments of the disclosure generally relate to an electrically conductive terminal, and to a method for manufacturing the electrically conductive terminal.

### BACKGROUND

In the field of electrical connectors, silver-plated electrically conductive terminals are widely used in the contact interface of the connector due to their excellent conductivity. However, the use of silver creates significant problems that are difficult to overcome. More specifically, conventional silver-plated electrically conductive terminals usually use copper alloy as the conductive metal base layer. A nickel plating layer is plated on the surface of the copper alloy, and then a silver plating layer is plated on the surface of the nickel plating layer. In practice, the silver plating layer is exposed to the air. Due to its relatively large porosity, the silver plating layer is prone to vulcanization reactions with sulfur and chlorine elements in the air. This results in a series of important problems in conventional silver-plated electrically conductive terminals that are difficult to overcome, such as silver's discoloration and high friction coefficients.

### SUMMARY

According to an embodiment of the present disclosure, a method for manufacturing an electrically conductive terminal includes steps of plating a nickel plating layer on a surface of the conductive metal base layer, plating a silver plating layer on a surface of the nickel plating layer, and plating a tin plating layer on a surface of the silver plating layer.

### BRIEF DESCRIPTION OF THE DRAWINGS

The invention will now be described by way of example with reference to the accompanying Figures, of which:

FIG. 1 is a schematic structural view of an electrically conductive terminal according to an exemplary embodiment of the present disclosure.

FIG. 2 is a photograph of a silver-tin mixed layer in the electrically conductive terminal according to an exemplary embodiment of the present disclosure under a SEM/EDX instrument.

FIGS. 3A and 3C respectively are photographs of the electrically conductive terminal according to an exemplary embodiment of the present disclosure under a SEM/EDX instrument, and FIG. 3B illustrates parameters at rectangular test points on the sample of FIG. 3A.

FIG. 4 is a photograph of the electrically conductive terminal according to an exemplary embodiment of the present disclosure under a discoloration resistance test.

FIG. 5 is a photograph of the electrically conductive terminal according to an exemplary embodiment of the present disclosure under a first corrosion resistance test.

FIG. 6 is a photograph of the sample T3 in the first test group of FIG. 5 after the salt spray test lasted for 120 hours, and FIG. 6A, FIG. 6B and FIG. 6C show respectively parameters at test points A, B and C on the sample T3 of FIG. 6.

FIG. 7 is a photograph of the electrically conductive terminal according to an exemplary embodiment of the present disclosure under a second corrosion resistance test.

FIG. 8A is a graph of the electrically conductive terminal according to an exemplary embodiment of the present disclosure being conducted an electronic contact resistance test, and

FIG. 8B is a graph of the electrically conductive terminal according to the exemplary embodiment of the present disclosure being conducted an electronic contact resistance test after being conducted a first corrosion resistance test thereon.

FIG. 9A is a curve of the electrically conductive terminal according to the exemplary embodiment of the present disclosure being conducted an electronic contact resistance test before being conducted the second corrosion resistance test thereon.

FIG. 9B is a curve of the electrically conductive terminal according to the exemplary embodiment of the present disclosure being further conducted an electronic contact resistance test after being conducted the second corrosion resistance test thereon.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a method for manufacturing an electrically conductive terminal is provided and includes steps of: 1) plating a nickel plating layer on a surface of a conductive metal base layer; 2) plating a silver plating layer on a surface of the nickel plating layer; and 3) plating a tin plating layer on a surface of the silver plating layer. Further, silver elements in the silver plating layer and tin elements in the tin plating layer diffuse mutually to form a silver-tin mixed layer. The surface of the tin plating layer is oxidized to form a tin oxide film layer.

According to another embodiment of the present disclosure, an electrically conductive terminal includes: 1) a conductive metal base layer; a nickel plating layer formed on a surface of the conductive metal base layer; 2) a silver plating layer formed on a surface of the nickel plating layer; and 3) a tin plating layer is formed on a surface of the silver plating layer. Silver elements in the silver plating layer and tin elements in the tin plating layer diffuse mutually to form a silver-tin mixed layer. The surface of the tin plating layer is oxidized to form a tin oxide film layer.

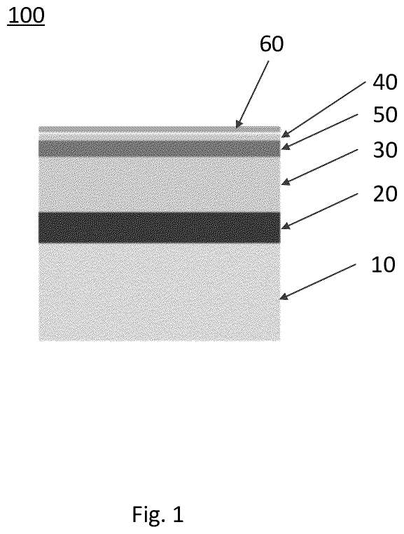

As shown in FIG. 1, a method for manufacturing an electrically conductive terminal includes: plating a nickel plating layer 20 on a surface of the conductive metal base layer 10; plating a silver plating layer 30 on a surface of the nickel plating layer 20; and plating a tin plating layer 40 on a surface of the silver plating layer 30. Silver elements in the silver plating layer 30 and tin elements in the tin plating layer 40 diffuse mutually to form a silver-tin mixed layer 50. The surface of the tin plating layer 40 is oxidized to form a tin oxide film layer 60. It should be noted that the layers from bottom to top shown in FIG. 1 represent the layers of the electrically conductive terminal from inside to outside.

Preferably, according to the present disclosure, the method for manufacturing the electrically conductive terminal may further include coating the surface of the tin oxide thin film layer 60 with a lubricant layer, so as to further reduce the friction coefficient of the terminal surface. Further a sub-base layer may be plated on the surface of the conductive metal base layer 10. The nickel plating layer 20 may be plated on a surface of the sub-base layer. In an exemplary embodiment of the present disclosure, the conductive metal base layer may be a copper alloy layer, and the sub-base layer may be a copper plating layer.

According to the present disclosure, in the method for manufacturing the electrically conductive terminal, a hardness reinforcer may be added to the plating solution used in the plating process. In an exemplary embodiment of the present disclosure, the hardness reinforcer may include at least one of nickel, copper, iron, and zinc.

As shown in FIG. 1, an electrically conductive terminal 100 includes the electrically conductive metal base layer 10; the nickel plating layer 20 formed on a surface of the conductive metal base layer 10; the silver plating layer 30 formed on a surface of the nickel plating layer 20; and the tin plating layer 40 formed on a surface of the silver plating layer 30. Silver elements in the silver plating layer 30 and tin elements in the tin plating layer 40 diffuse mutually to form the silver-tin mixed layer 50. The surface of the tin plating layer 40 is oxidized to form the tin oxide thin film layer 60. Preferably, the electrically conductive terminal 100 may further include a lubricant layer coated on the surface of the tin oxide film layer 60. Preferably, the electrically conductive terminal 100 may further include a sub-base layer formed on the surface of the conductive metal base layer 10. The nickel plating layer 20 is formed on a surface of the sub-base layer. In an exemplary embodiment, the conductive metal base layer 10 is a copper alloy layer and the sub-base layer is a copper plating layer.

The electrically conductive terminal manufactured by the method for manufacturing the electrically conductive terminal provided in the present disclosure has excellent discoloration resistance, excellent corrosion resistance, low contact resistance at the same level, and lower friction coefficient, etc., and can be applied to high-current electronic connector's contact interface and other related plating parts.

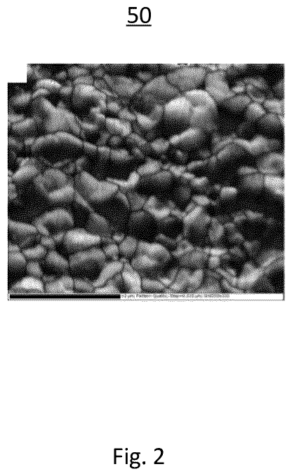

FIG. 2 is a photograph of the plated surface in the electrically conductive terminal according to an exemplary embodiment of the present disclosure obtained under SEM/EDX (Scanning Electron Microscope/Energy Dispersive X-ray spectroscopy) instrument. The function of the scanning electron microscope (SEM) is microstructure imaging analysis. The function of the energy dispersive x-ray spectrometer (EDX) is to analyze the relative content of the elements in the sample. Specifically, by means of analyzing the wavelength and intensity of the element characteristic X-rays emitted by the sample, the spectrometer determines the elements contained in the sample according to the wavelength, and determines the relative content of the elements according to the intensity. FIG. 2 shows that the silver and tin elements in the mixed layer diffused sufficiently to cover the silver plating layer and prevent the silver plating layer from being directly exposed to the air.

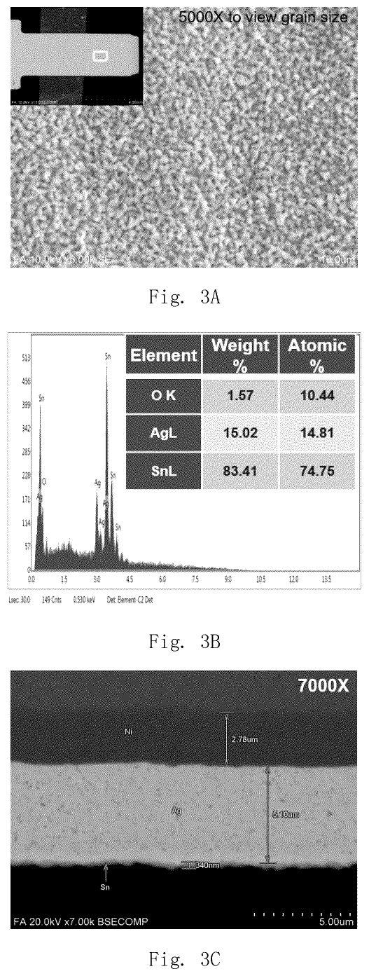

FIG. 3A and FIG. 3C are photographs of electrically conductive terminals according to an exemplary embodiment of the present disclosure obtained by using SEM/EDX instrument. FIG. 3B shows relevant parameters of elements contained in rectangular test points on the sample in FIG. 3A. The upper left corner of FIG. 3A is a photograph of the real electrically conductive terminal, and the main view of FIG. 3A shows the particle size surface of the electrically conductive terminal observed under the 5000× magnification instrument of the selected part by the rectangular box in the upper left corner of the real photograph.

The abscissa in the coordinate axis shown in FIG. 3B represents the energy released by element transition (unit: EV), and the ordinate represents the energy value. In the chart shown in FIG. 3B, “Element” represents the element contained in the test point, “OK” represents the oxygen element O contained in the test point in the electrically conductive terminal provided by the exemplary embodiment of the present disclosure, and “AgL” represents the silver element Ag contained in the test point in the electrically conductive terminal provided by the exemplary embodiment of the disclosure, “SnL” represents the tin element Sn contained in the test point in the electrically conductive terminal provided by the exemplary embodiment of the present disclosure, and “Weight %” represents the weight percentage of the element contained in the test point, “Atomic %” means the atomic number percentage of the element contained in the test point. It can be concluded from FIG. 3B that, in the electrically conductive terminal provided by the exemplary embodiment of the present disclosure, the main element on the plated surface is Sn, followed by Ag, and trace element O.

FIG. 3C is a diagram of the thickness of the electrically conductive terminal provided by the exemplary embodiment of the present disclosure observed under a 7000× magnification instrument. In the example shown in FIG. 3C, in the plated surface of the electrically conductive terminal provided by the exemplary embodiment of the present disclosure, the thickness of the nickel plating layer (Ni) is about 2.78 μm, the thickness of the silver plating layer (Ag) is about 2.78 μm, and the thickness of the interface between the silver plating layer and the tin plating layer (Sn) is about 340 nm, wherein the silver-tin mixed layer is located within this interface.

From FIG. 3A to FIG. 3C, it can be concluded that the electrically conductive terminal provided by the exemplary embodiment of the present disclosure is coated with a nickel plating layer on the surface of the copper alloy, and then coated with a silver plating layer on the surface of the nickel plating layer. Then, a relatively thin tin plating layer is plated on the surface of the silver plating layer. First, as the tin plating layer is directly exposed in the air, the tin oxide layer may be formed with relative ease. The generated tin oxide layer overcomes and compensates for the defect of the large porosity of the tin plating layer, which makes the plated silver exposed to the air and subjects vulcanization reaction with sulfur, chlorine in the air. Secondly, the tin element, the tin oxide element and the silver element in the tin plating layer, the generated tin oxide layer and the silver plating layer diffuse mutually to form a silver-tin mixed layer. In this way, in the plated surface of the electrically conductive terminal, the tin plating layer, the tin oxide layer and the silver-tin mixed layer work together to play the role of an inhibitory layer to prevent the plated silver from sulfidation and discoloration. Further, compared with the conventional silver-plated electrically conductive terminal, in the electrically conductive terminal provided by the exemplary embodiment of the present disclosure, the structure of the plated surface avoids the influence of the formation of silver film due to silver sulfide and silver chlorination on the contact resistance of the contact interface, thereby the electrically conductive terminal provided by the exemplary embodiment of the present disclosure exhibits the same level of contact resistance performance, and a more stable contact resistance change rate, and at the same time, reduces the adhesion when the plated silver is used as the contact interface, and improves the coefficient of friction of the contact interface.

[Anti-Discoloration Performance Test]

Table 1 shows the relevant data of each sample test group in the anti-discoloration performance evaluation test of the electrically conductive terminal provided by the exemplary embodiment of the present disclosure

TABLE 1

| | | | | | | Ag/Sn |
|---|---|---|---|---|---|---|
| | | Nickel plating | Silver plating | Sn flash plating | | thickness |
| Test Group | Thickness Item | 112-25-2 | 112-32-2 | 112-65-1 | Post-treatment | ratio |
| Test Group 1 | T1 | 1.27~3.81 um | 3~7 um | 0.1~0.3 um | no | 25:1 |
| AgMs | T2 | | | 0.3~0.6 um | no | 11:1 |
| | T3 | | | 0.6~1.0 um | no | 6:1 |
| Test Group 2 | T1 | 1.27~3.81 um | 3~7 um | 0.1~0.3 um | Inhibitor U | 25:1 |
| AgMs + U | T2 | | | 0.3~0.6 um | Inhibitor U | 11:1 |
| | T3 | | | 0.6~1.0 um | Inhibitor U | 6:1 |

Referring to Table 1, the vertical column in the table is the category of the sample test group: the samples used in the first test group (Test Group 1) are the electrically conductive terminals provided by the exemplary embodiment of the present disclosure, and the second test group (Test Group 2) is the electrically conductive terminal provided by the exemplary embodiment of the present disclosure with an inhibitor U added. The horizontal columns in the table include: Test Group, Thickness Item, Nickel plating, Silver plating, Sn flash plating, inhibitor-treatment, and the thickness ratio between the silver plating layer/tin plating layer (Ag/Sn thickness). It can be seen from Table 1 that each test group includes three sample items T1, T2 and T3, and the thickness of the thin tin plating layer in different sample items is different, so that the thickness ratio between the silver plating layer/tin plating layer is also different. The samples in the first test group have no inhibitor added and the samples in the second test group have the inhibitor added.

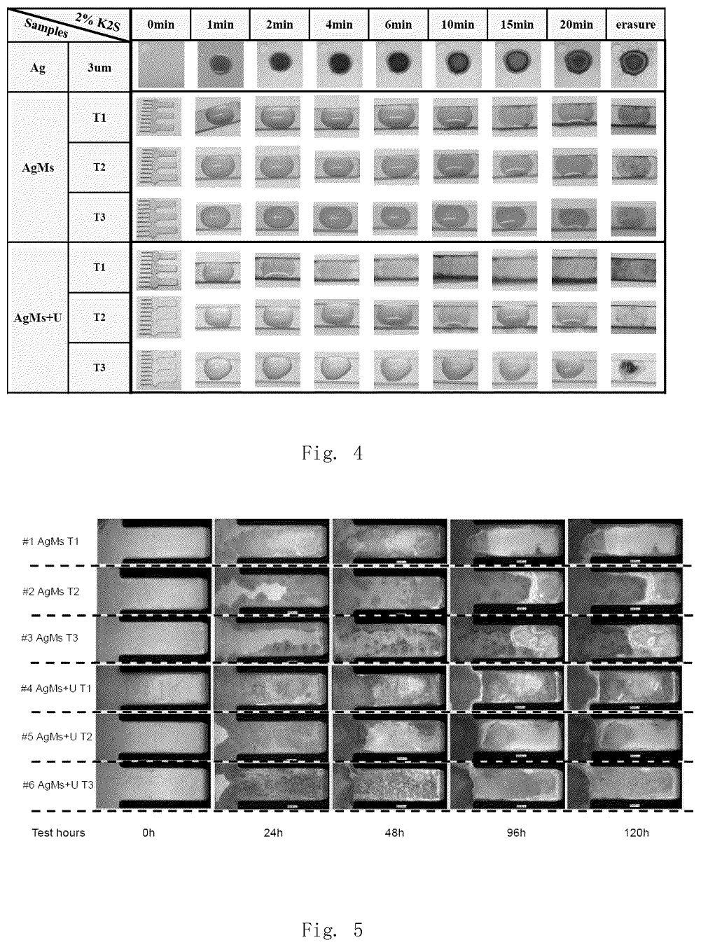

FIG. 4 shows the results of a silver discoloration test performed on the electrically conductive terminal according to an exemplary embodiment of the present disclosure, showing the test results of conducting the silver discoloration test method on a sample of a conventional silver-plated electrically conductive terminal and the sample in each of the test groups in Table 1 using a 2% potassium sulfide (K2S) solution. The vertical columns in FIG. 4 are the conventional silver-plated electrically conductive terminal samples (Ag, with a thickness of 3 μm) and the samples in the first test group (AgMs) and the samples in the second test group (AgMs+U) in Table 1, respectively. The horizontal column in FIG. 4 indicates the length of time (unit: min) for each sample immersing in 2% potassium sulfide (K2S) solution, so it can be seen from FIG. 4 the sample status after the test time of each solution test and the sample status after being wiped off the solution.

From FIG. 4, it can be concluded that: (1) the conventional silver-plated electrically conductive terminal sample (Ag) shows obvious discoloration after the solution test lasted for 2 minutes; (2) each sample in the first test group (AgMs) and the second test group (AgMs+U) has no obvious discoloration; further, even in case that the solution test time is 20 min, the T2 sample in the first test group (AgMs) and the second test group (AgMs+U) are almost never discolored, thereby reflecting that the electrically conductive terminal provided by the exemplary embodiment of the present disclosure has better anti-discoloration performance compared with conventional silver-plated electrically conductive terminals; (3) there is no clear difference between the first test group (AgMs) and the second test group (AgMs+U), it can be seen that the electrically conductive terminal provided by the exemplary embodiment of the present disclosure can achieve good anti-discoloration performance regardless of whether the discoloration inhibitor (U) is added or not; that is, the electrically conductive terminals provided by the exemplary embodiment of the present disclosure do not require additional discoloration inhibitors (U).

With the above tests, it can be seen that, compared with conventional silver-plated electrically conductive terminals, the electrically conductive terminal provided by the exemplary embodiments of the present disclosure has better anti-tarnish performance.

[Corrosion Resistance Performance Test]

Salt Spray Test Method

FIG. 5 shows the results of the corrosion resistance test performed on the electrically conductive terminal according to the exemplary embodiment of the present disclosure, specifically showing the sample plated surface appearance of the electrically conductive terminal provided by the exemplary embodiment of the present disclosure in the salt spray test environment under the SEM/EDX instrument. The vertical columns in FIG. 5 are the three samples T1, T2 and T3 in the first test group (AgMs), and the three samples T1, T2 and T3 in the second test group (AgMs+U). Samples in the first test group have no inhibitor added and samples in the second test group have inhibitor added. The horizontal column in FIG. 5 indicates the salt spray test time (unit: hour h) of each of the above samples, which are 0 h, 24 h, 48 h, 96 h and 120 h respectively. In this way, from FIG. 5 it can see the sample appearance after each salt spray test duration.

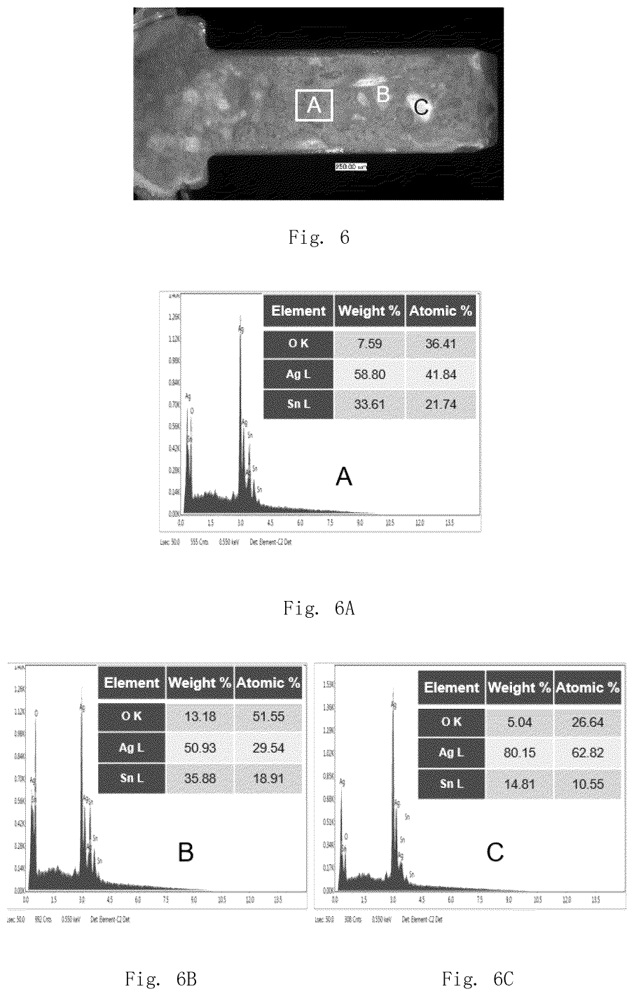

FIG. 6 is a photograph of sample T3 in the first test group (AgMs) in FIG. 5 after conducting the salt spray test lasted for 120 hours, which is obtained under SEM/EDX instrument. FIGS. 6A, 6B and 6C show parameters at test points A, B and C, respectively, on sample T3 in the first test group (AgMs) shown in FIG. 6. The abscissa in each of the coordinate axes shown in FIG. 6A, FIG. 6B and FIG. 6C represents the energy released by element transition (unit: EV), and the ordinate represents the energy value. In the charts shown in FIG. 6A, FIG. 6B and FIG. 6C, “Element” indicates the element contained in the test point A, B or C on the plated surface of sample T3 in the first test group (AgMs) shown in FIG. 6, “OK” indicates the oxygen element O contained in the test point A, B or C, “AgL” indicates the silver element Ag contained in the test point A, B or C, “SnL” indicates the Tin element Sn contained in the test point A, B or C, “Weight %” indicates the weight percentage of the element contained in the test point A, B or C, and “Atomic %” indicates the atomic number percentage of the element contained in the test point A, B or C. From FIGS. 5 to 6C, it can be concluded that the oxidation state of the plated surface of the sample T3 in the first test group (AgMs) shown in FIG. 6. Although there is no standard visual quality assessment to define the relationship between the color of the plated surface of sample T3 and the severity degree of corrosion, it is possible to choose whether there are large black corrosion spots on the plated surface of sample T3 for visual quality assessment. Even though the electrically conductive terminal provided by the exemplary embodiment of the present disclosure has undergone a salt spray test lasted for 120 hours, no large black corrosion spots appear on the surface of the sample.

Mixed Flowing Gas (MFG) Test Method

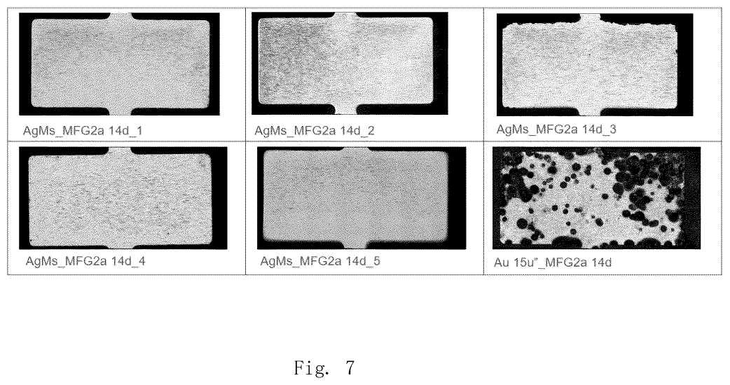

FIG. 7 shows the result of the corrosion resistance test of the electrically conductive terminal according to the exemplary embodiment of the present disclosure, specifically showing the surface appearances of the plated surface of different samples of the electrically conductive terminal provided by the exemplary embodiment of the present disclosure and the gold-plated electrically conductive terminal sample in the related art in the mixed flow gas (MFG) test environment under the SEM/EDX instrument. The Mixed Flowing Gas (MFG) test is another accelerated test method used to evaluate the corrosion resistance of non-precious metal coatings according to the EIA-364 test standard, which is also used to evaluate the susceptibility to silver tarnish. In the MFG test experiment shown in FIG. 7, following the EIA-364-65 Class Ha test standard, sample appearances of the electrically conductive terminal (AgMs) provided by the exemplary embodiment of the present disclosure and gold-plated (Au) electrically conductive terminal in the related art as a comparative example have been tested respectively after being in a mixed flowing gas (MFG) test environment lasted for 14 days. As shown in FIG. 7, compared with the gold-plated (Au) electrically conductive terminal sample in the related art as a comparative example, sample of the electrically conductive terminal provided by the exemplary embodiment of the present disclosure has better MFG corrosion resistance.

The above tests show that the electrically conductive terminal provided by the exemplary embodiment of the present disclosure has excellent corrosion resistance.

[Electronic Contact Resistance Performance Test]

Electronic Contact Resistance Performance Test+Salt Spray Test Method

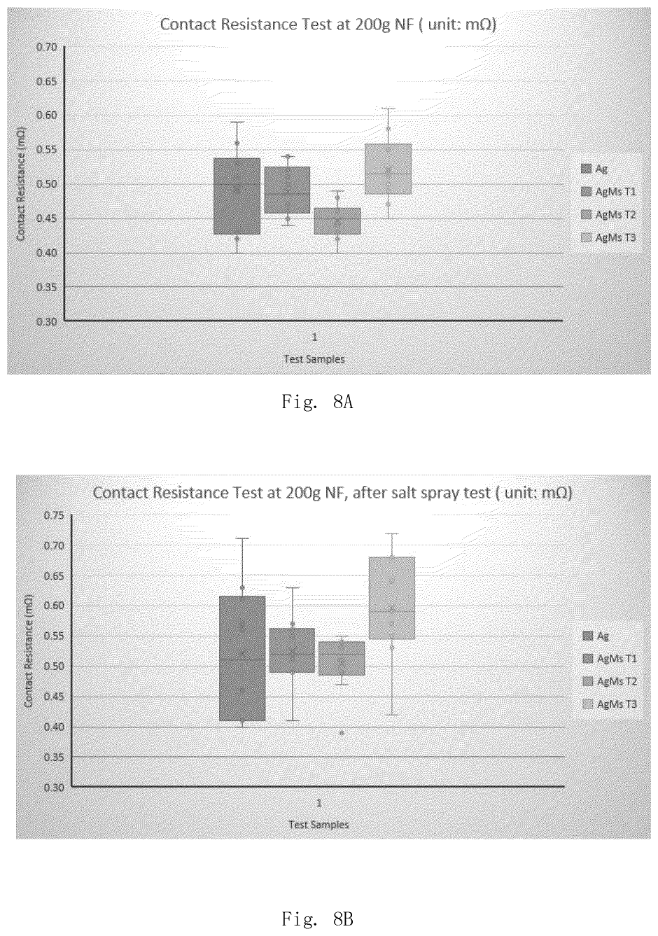

FIG. 8A is a graph of an electrically conductive terminal according to an exemplary embodiment of the present disclosure being conducted an electronic contact resistance test, and FIG. 8B is a graph of the electrically conductive terminal according to an exemplary embodiment of the present disclosure being further conducted an electronic contact resistance test after being conducted a salt spray test. In each of FIG. 8A and FIG. 8B, the horizontal axis of the coordinate axis indicates the conventional silver-plated electrically conductive terminal sample (Ag), and the first sample (AgMs T1) and the second sample (AgMs T2) and the third sample (AgMs T3) of the electrically conductive terminal according to an exemplary embodiment of the present disclosure, and the vertical axis of the coordinate axis indicates the variation range (unit: milliohm m Ω) of the contact resistance of each sample under the condition of applying 200 grams of normal force (200 g NF).

According to the test results shown in FIG. 8A, the following conclusions can be drawn.

(1) The electronic contact resistance data of AgMs (that is, the sample of the electrically conductive terminal provided by the present disclosure) is basically at the same level as that of conventional silver-plated product (that is, the sample of the conventional silver-plated electrically conductive terminal).

0.4˜0.6 m Ω (initial state of AgMs) vs 0.49 m Ω (initial state of conventional silver-plated product)

0.4˜0.7 m Ω (final state of AgMs) vs 0.52 m Ω (final state of conventional silver-plated product)

(2) Compared with the conventional silver-plated product, the data about electronic contact resistance change rate of AgMs is more stable.

0.09˜0.16 m Ω (initial state of AgMs) vs 0.19 m Ω (initial state of conventional silver-plated product)

0.16˜0.30 m Ω (final state of AgMs) vs 0.31 m Ω (final state of conventional silver-plated product)

(3) Among the different test samples of AgMs, compared with other test samples, AgMs T2 is most stable in term of electronic contact resistance stability. Based on this, AgMs T2 will be the best choice in term of thickness for the method (plating process) for manufacturing the electrically conductive terminal provided by the present disclosure.

In addition, it can be seen from FIG. 8B that, after the salt spray test, the change range of the electronic contact resistance of the conventional silver-plated electrically conductive terminal sample (Ag) is increased significantly, while the range change of the electrically conductive terminal samples (AgMs T1, AgMs T2 and AgMs T3) is remained stable.

Electronic Contact Resistance Performance Test+Mixed Flowing Gas (MFG) Test Method

In conjunction with FIG. 7, it can be seen that after being conducted the second corrosion resistance performance test (i.e. MFG test), AgMs (that is, the sample of the electrically conductive terminal provided by the present disclosure) has excellent corrosion resistance; moreover, AgMs has better corrosion resistance compared with the sample of the gold-plated (Au) electrically conductive terminal in the related technology as a comparative example.

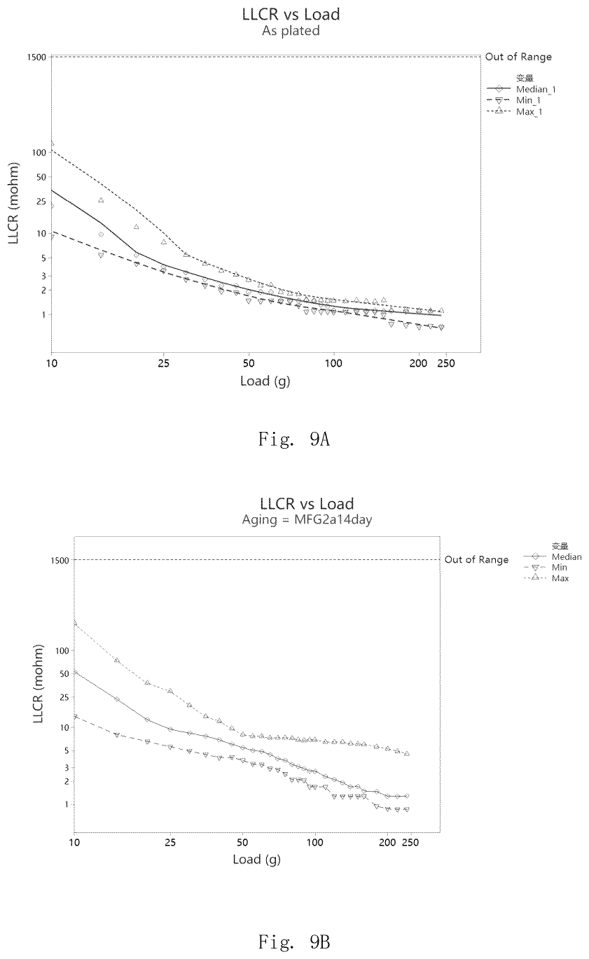

FIG. 9A shows a curve of the electrically conductive terminal according to the exemplary embodiment of the present disclosure being conducted the electronic contact resistance test before being conducted the second corrosion resistance test, and FIG. 9B shows a curve of the electrically conductive terminal according to the exemplary embodiment of the present disclosure being further conducted the electronic contact resistance test after being conducted the second corrosion resistance test (see the above content about “Mixed Flowing Gas (MFG) Test Method”) lasted for 14 days.

In each of FIG. 9A and FIG. 9B, the horizontal axis of the coordinate axis represents the magnitude of the positive force load (Load) (unit: gram force g), while the vertical axis of the coordinate axis represents the magnitude of the contact resistance value (LLCR) (unit: milliohm (mohm). In each of FIGS. 9A and 9B, the upper curve is the maximum variation curve, the middle curve is the median variation curve, and the lower curve is the minimum variation curve. Comparing the curve in FIG. 9A with the curve in FIG. 9B, it can be seen that when the applied normal force load (Load) is about 200 g, the median variable curve is relatively stable, and the contact resistance value is about 1 mohm. In addition, comparing the curves in FIG. 9A with the curves in FIG. 9B, it can be seen that AgMs (that is, the sample of the electrically conductive terminal provided in the present disclosure) exhibits the same level electronic contact resistance performance before and after being conducted the second corrosion resistance performance test (i.e., the MFG test).

Through the above tests, it can be seen that the electrically conductive terminal provided by the exemplary embodiments of the present disclosure have low contact resistance under the same level.

[Friction Coefficient Test]

Table 2 shows the friction coefficient and hardness values of the electrically conductive terminal provided by the exemplary embodiment of the present disclosure and each element in the friction coefficient evaluation test. The horizontal columns in Table 2 are respectively nickel element (Ni), tin elements (Sn), gold element (Au (Hard)), silver elements (Ag) and the electrically conductive terminal (AgMs) provided by the exemplary embodiment of the present disclosure, while the vertical columns are the coefficient of friction (CoF) and hardness value (Hardness HV) of each element respectively.

TABLE 2

| | Ni | Sn | Au(Hard) | Ag | AgMs |
|---|---|---|---|---|---|
| CoF | 0.4~1.0 | 0.5~0.9 | 0.3 | 1.0~2.0 | 0.3~0.8 |
| Hardness HV | 150~700 | 10~25 | 130~200 | 70~100 | 90~170 |

It can be seen from Table 2 that, compared with conventional silver-plated terminals (the friction coefficient ranges from 1.0 to 2.0, and the variation amplitude is 1.0 (i.e., 2.0-1.0=1.0)), variation range of the friction coefficient of the electrically conductive terminal (AgMs) provided by the exemplary embodiment of the present disclosure is 0.3-0.8, and the variation magnitude is 0.5 (i.e., 0.8-0.3=0.5), thus having a better friction coefficient and being more stable. Therefore, by virtue of its better friction coefficient, the electrically conductive terminal provided by the exemplary embodiment of the present disclosure is beneficial to reduce the friction coefficient of the separable contact interface of the connector, and is beneficial to alleviate the problem of large friction coefficient and high change rate of conventional silver-plated product terminal, and overcomes the problems of large and unstable insertion force of conventional silver-plated terminal.

It can be seen from the above that, according to the method for manufacturing an electrically conductive terminal provided by each of the aforementioned exemplary embodiments of the present disclosure, the electrically conductive terminal manufactured by this method has excellent silver discoloration inhibition ability, excellent corrosion resistance, and low contact corrosion resistance under the same level, low friction coefficient and so on, which can be applied to the contact interface of high-current electronic connectors and other related plating parts.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A method for manufacturing an electrically conductive terminal, comprising:
plating a nickel plating layer on a surface of a conductive metal base layer;
plating a silver plating layer on a surface of the nickel plating layer; and
plating a tin plating layer on a surface of the silver plating layer.

2. The method for manufacturing the electrically conductive terminal according to claim 1, further comprising forming a silver-tin mixed layer.

3. The method for manufacturing the electrically conductive terminal according to claim 2, wherein the silver-tin mixed layer is formed by mutually diffusing silver elements in the silver plating layer and tin elements in the tin plating layer.

4. The method for manufacturing the electrically conductive terminal according to claim 2, further comprising oxidizing a surface of the tin plating layer to form a tin oxide film layer.

5. The method for manufacturing the electrically conductive terminal according to claim 4, further comprising coating a surface of the tin oxide film layer with a lubricant layer.

6. The method for manufacturing the electrically conductive terminal according to claim 1, further comprising plating a sub-base layer on the surface of the conductive metal base layer.

7. The method for manufacturing the electrically conductive terminal according to claim 6, wherein the nickel plating layer is plated on a surface of the sub-base layer.

8. The method for manufacturing the electrically conductive terminal according to claim 7, wherein the conductive metal base layer is a copper alloy layer.

9. The method for manufacturing the electrically conductive terminal according to claim 8, wherein the sub-base layer is a copper plating layer.

10. The method for manufacturing the electrically conductive terminal according to claim 1, wherein a hardness reinforcer is added to a plating solution used in the plating of at least one of the nickel layer, the silver plating layer or the tin plating layer.

11. The method for manufacturing the electrically conductive terminal according to claim 10, wherein the hardness reinforcer comprises at least one of nickel, copper, iron and zinc.

12. An electrically conductive terminal comprising:
a conductive metal base layer;
a nickel plating layer formed on a surface of the conductive metal base layer;
a silver plating layer formed on a surface of the nickel plating layer; and
a tin plating layer formed on a surface of the silver plating layer.

13. The electrically conductive terminal according to claim 12, further comprising a silver-tin mixed layer.

14. The electrically conductive terminal according to claim 13, wherein silver elements in the silver plating layer and tin elements in the tin plating layer diffuse mutually to form the silver-tin mixed layer.

15. The electrically conductive terminal according to claim 14, wherein a surface of the tin plating layer is oxidized to form a tin oxide film layer.

16. The electrically conductive terminal according to claim 15, further comprising a lubricant layer coated on a surface of the tin oxide thin film layer.

17. The electrically conductive terminal according to claim 12, further comprising a sub-base layer formed on the surface of the conductive metal base layer.

18. The electrically conductive terminal according to claim 17, wherein the nickel plating layer is formed on a surface of the sub-base layer.

19. The electrically conductive terminal according to claim 17, wherein the conductive metal base layer is a copper alloy layer.

20. The electrically conductive terminal according to claim 19, wherein the sub-base layer is a copper plating layer.
